(19) United States
(12) Patent Application Publication
(10) Pub. No.: US 2013/0146529 A1
(43) Pub. Date: Jun. 13, 2013

(54) FILTER MATERIAL FOR FLUIDS

(71) Applicants: Matthias Schwender, Kirkel (DE); Andreas Schmitz, Kirkel (DE); Edwin Koch, Tholey (DE)

(72) Inventors: Matthias Schwender, Kirkel (DE); Andreas Schmitz, Kirkel (DE); Edwin Koch, Tholey (DE)

(21) Appl. No.: 13/261,514

(22) PCT Filed: May 27, 2011
(86) PCT No.: PCT/EP2011/002641

§ 371 Date: Feb. 22, 2013

(30) Foreign Application Priority Data
Jun. 23, 2010 (DE) 10 2010 025 218.2

(51) Int. Cl. B01D 29/00

(52) U.S. Cl. CPC B01D 29/00
USPC 210/490; 210/483; 210/489; 210/493.5

(57) ABSTRACT

The invention relates to a filter material for fluids, in particular hydraulic fluids, comprising a single- or multi-layered filter medium (6) and a supporting structure which rests flatly on the at least one side thereof and consists of at least one individual fabric (10, 12) made of warp threads (28) and weft threads (32). Said filter material is characterized in that at least one set of warp threads (28) and/or weft threads (32) overlaps three or more adjacent warp threads (28) and/or weft threads (32) while forming a long-float weave.

The invention relates to a filter material for fluids, in particular for hydraulic fluids, comprising a single-layer or multi-layer filter medium and a support structure which rests flatly on the at least one side thereof and which consists of at least one individual fabric made from warp and weft threads.

Filter materials for producing interchangeable filter elements in hydraulic systems are known in diverse configurations and consist, for example, of a filter nonwoven, preferably of multiple layers, with a support structure on one or both sides (incident flow side or outflow side). For example, a hydraulic fluid which is to be filtered flows through such filter elements, with a considerable pressure difference arising at times from the unfiltered side to the filtered side. To be able to withstand this pressure difference and also dynamic flow forces in the unfiltered material, the filter materials from which such filter elements are produced have so-called support structures. Such support structures are subjected to cyclic pressure loading in the operation of a filter element.

Known support structures are generally formed from metal fabrics, in particular fabrics of high-grade steel wires. In the prior art, for example, from DE 27 18 581 C2, such fabrics are made in the form of standard fabrics in the manner of a so-called plain weave, with the threads always being woven in alternation over and then again under the next thread. Such conventional support structures do not equally satisfy the two requirements to be imposed, specifically the high mechanical strength and with the fluid permeability as high as possible. In this type of weave, larger mesh sizes do result in lower flow resistances. On the other hand, a high resistivity to cyclic pressure loading in this type of weave dictates relatively small mesh sizes.

With respect to these problems, the object of the invention is to provide a filter material in which the support structure ensures especially high mechanical strength in spite of a high fluid permeability to be achieved.

According to the invention, this object is achieved by a filter material having the features specified in claim 1 in its entirety.

According to the characterizing part of claim 1, an important feature of the invention lies in the fact that the support structure has at least one individual fabric which is made in a type of weave which differs from a standard fabric, with the warp threads and/or weft threads being woven in a long-float weave such that floats are formed with passages of the thread over more than two, i.e., three or more adjacent threads. A much better compromise with respect to good strength properties and high fluid permeability can be achieved by this type of weave.

Advantageously, the arrangement is such that the at least one set of warp threads and/or weft threads forms an individual fabric in a satin weave, with provision being made such that there is a thread passage over four adjacent threads in the weaving cycle, for example, by the warp threads being woven running over four adjacent weft threads at a time.

In especially advantageous exemplary embodiments, in addition to the first individual fabric, preferably in a satin weave, there can be a second individual fabric, with the two individual fabrics being connected to one another via woven-in binding threads.

Advantageously, the arrangement here can be made such that the binding threads as binding warp threads are woven into the fabric structure in addition to the warp threads of the two individual fabrics.

If the additional second individual fabric is made in a plain weave, to form an advantageous fabric structure, it is possible to proceed such that the binding warp threads pass over every fourth weft thread of the plain weave of the second individual fabric and pass under every fifth weft thread of the satin weave of the first individual fabric.

Warp threads and/or weft threads of at least one individual fabric can especially advantageously consist of metal wire, especially high-grade steel, or of plastic.

The binding warp threads can likewise consist of metal wire, especially high-grade steel, or of plastic.

Especially good strength properties can be achieved when the support structure has a nonwoven, preferably a coated polyester nonwoven, onto which the at least one individual fabric is laminated.

The subject matter of the invention is also a filter element, in particular a cylindrical filter element, having a plurality of individual filter folds, comprising a filter material according to the invention which is provided with a support structure on one or both sides.

The invention is detailed below using the drawings.

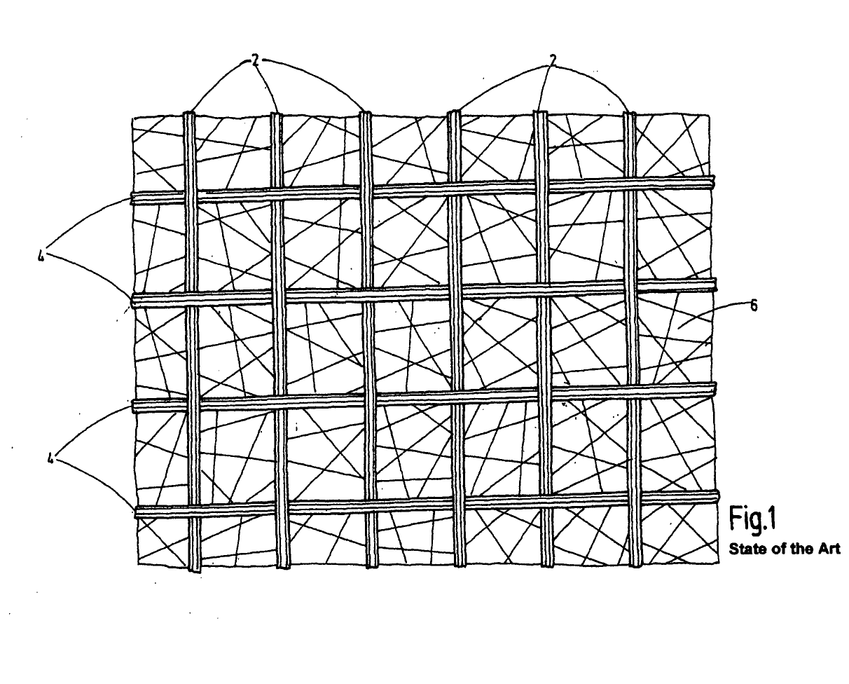

FIG. 1 shows a microscopically enlarged extract of a filter material according to the prior art;

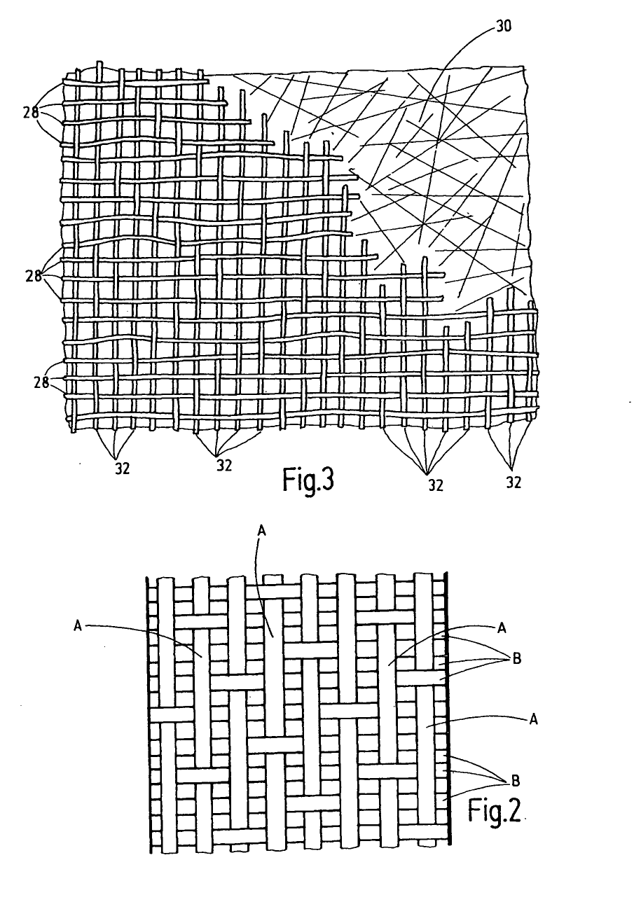

FIG. 2 shows a schematic of the weave pattern of a satin weave;

FIG. 3 shows a cutaway extract which has been enlarged approximately five times compared to a practical embodiment of an individual fabric intended for the filter material according to the invention in the form of a satin weave;

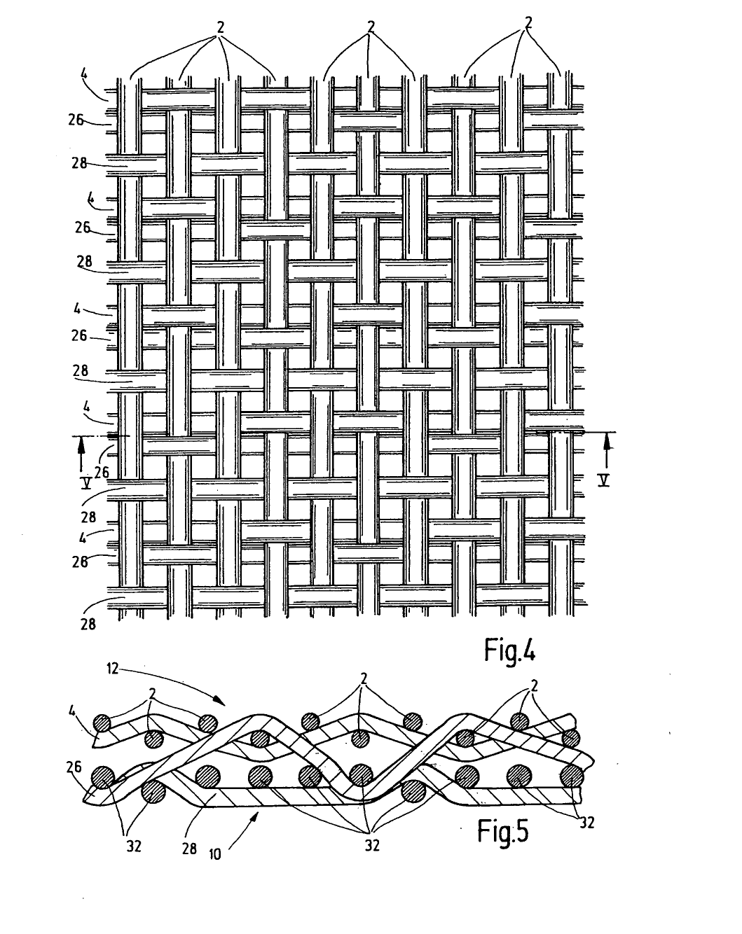

FIG. 4 shows an extract of the support structure of one exemplary embodiment which is shown greatly enlarged compared to FIG. 3, with a support structure formed from two individual fabrics, looking at the individual fabric executed as a standard fabric, and

FIG. 5 shows a section according to the intersection line V-V from FIG. 1.

FIG. 1 shows a greatly enlarged extract of a filter material according to the prior art, looking at the support structure made in the form of a high-grade steel fabric. The fabric of weft threads 2 and warp threads 4 is made as a standard fabric in a plain weave, with the mesh size in the weft direction being approximately 970 μm and in the warp direction approximately 890 μm, at a thickness of the weft threads of approximately 150 μm and of the warp threads of approximately 170 μm. The fabric rests flatly on the filter medium 6.

FIG. 3 shows an enlarged extract of a filter material according to one exemplary embodiment of the invention in which the support structure is formed from an individual fabric whose type of weave differs from a standard fabric in that there is a long-float weave in which there is a thread passage over more than two adjacent threads. The exemplary embodiment of FIG. 3 is a satin fabric, as is shown in FIG. 2 as a thread diagram, wherein the threads designated as A, for example, in FIG. 2 pass over four adjacent threads at a time, designated as B, followed by the passage under the next following thread B. In the exemplary embodiment of FIG. 3, the warp threads 4 pass over four adjacent weft threads 2 at a time.

While the example of FIG. 3 is an individual fabric, FIGS. 4 and 5 show a modified example in which, in addition to an individual fabric 10 made in a satin weave, there is a second individual fabric 12 which is made in a standard weave (plain weave) and which forms a composite with the first individual fabric 10 and is utilized as a support fabric. The composite of the two individual fabrics 10, 12 is formed such that binding warp threads 26 in addition to the warp threads 4 of the standard fabric (individual fabric 12) and the warp threads 28 of the satin fabric (individual fabric 10) are woven in, with the binding warp threads 26 alternating with the warp threads 4 of the individual fabric 12, as is apparent from FIG. 4.

The section from FIG. 5 shows the interlacing of the binding warp threads 26. Proceeding from a passage under a weft thread 32 of the first individual fabric 10 (satin fabric), the binding warp threads 26 run at an angle of approximately 40° to the plane of the fabric as far as a passage over a weft thread 2 of the second individual fabric 12 (plain weave) and from there nm more steeply to the passage under a weft thread 32 of the first individual fabric 10, there being four weft threads 32 at a time between the passages under the weft threads 32. The passages over the weft threads 2 of the second individual fabric 12 take place on each fourth weft thread 2.

As has been shown, the replacement of standard fabrics by a different type of weave, such as the satin weave, leads to an optimal compromise of mechanical strength and permeability properties for fluids. This is especially the case in an example as shown in FIGS. 4 and 5, where the satin fabric is combined with a support fabric executed in a standard weave.

The properties of the support structure are especially good when the respective fabric, whether an individual fabric 10 in a satin weave by itself or a fabric composite of an individual fabric 10 and an individual fabric 12, does not directly rest on the filter medium 6, as is the case in FIG. 1 in the example of the filter material according to the prior art, but if the support structure is made such that the at least one individual fabric 10, 12 is laminated onto a nonwoven 30. Properties are especially good when the fabric 10, 12 is formed from plastic threads, for example, of polybutylene terephthalate, polypropylene, or polyester which is laminated onto a preferably coated nonwoven, for example, a polyester nonwoven or a nonwoven of PBT or PP. A laminate of this type leads to improved and stiffer support and moreover results in improved differential pressure behavior of the filter material and improved collapse stability. There is no distortion in the X direction; i.e., the material retains its shape much better than the two individual layers together. In addition, this laminate is thinner than the two individual layers, and more folds (surface) fit into the filter material. The laminate moreover has an improved drainage function that would exceed that of the two individual layers together; this is reflected in addition in a lower differential pressure in the filtration operation. FIG. 3 illustrates such an exemplary embodiment in which the individual fabric 10, which is executed as a satin fabric and which is woven from plastic threads 28 and 32, is laminated over the entire surface onto a coated polyester nonwoven which is designated as 30 in FIG. 3.

1. A filter material for fluids, in particular for hydraulic fluids, comprising:
a single-layer or multi-layer filter medium (6),
a support structure which rests flatly on the at least one side thereof and which consists of at least one individual fabric (10, 12) made of warp threads (28) and weft threads (32),
characterized in that at least one set of warp threads (28) and/or weft threads (32), with formation of a long-float weave, passes over three or more adjacent weft threads (28) and/or warp threads (32).

2. The filter material according to claim 1, characterized in that the at least one set of warp threads (28) and/or weft threads (32) forms an individual fabric (10) in a satin weave.

3. The filter material according to claim 1, characterized in that in addition to the first individual fabric (10) it has a second individual fabric (12), and that the two individual fabrics (10, 12) are connected to one another via woven-in binding threads (26).

4. The filter material according to claim 3, characterized in that the binding threads as binding warp threads (26) are woven into the fabric structure in addition to the warp threads (4, 28) of the two individual fabrics (10, 12).

5. The filter material according to claim 3, characterized in that the additional second individual fabric (12) is made in a plain weave.

6. The filter material according to claims 2, characterized in that the binding warp threads (26) pass over every fourth weft thread (2) of the plain weave of the second individual fabric (12) and pass under every fifth weft thread (32) of the satin weave of the first individual fabric (10).

7. The filter material according to claims 1, characterized in that warp threads (4, 28) and/or weft threads (2, 32) of at least one individual fabric (12, 10) consist of metal wire, especially high-grade steel, or of plastic.

8. The filter material according to claim 4, characterized in that the binding warp threads (26) consist of metal wire, especially high-grade steel, or of plastic.

9. The filter material according to claim 1, characterized in that the support structure has a nonwoven (30), preferably a coated polyester nonwoven, onto which the at least one individual fabric (10, 12) is laminated.

10. A filter element, especially a cylindrical filter element with a plurality of individual filter folds, consisting of a filter material according to one of the preceding claims, which is provided with a support structure (10, 12, 30) on one or both sides.
